(19) United States
(12) Patent Application Publication
(10) Pub. No.: US 2003/0176250 A1
(43) Pub. Date: Sep. 18, 2003

(54) Initial belt tensioner

(76) Inventors: Steven G. Austin, Littleton, CO (US); Alexander Serkh, Troy, MI (US)

Correspondence Address: Steven G. Austin, The Gates Corporation, Mail Stop 31-4-1-A3, 900 S. Broadway, Denver, CO, 80209, US

(21) Appl. No.: 10/388,821

(22) Filed: Mar. 14, 2003

Related U.S. Application Data
(60) Provisional application No. 60/364,819, filed on Mar. 15, 2002.

(51) Int. Cl. F16H 9/00; F16H 7/12; F16H 61/00; F16H 63/00

(52) U.S. Cl. 474/134; 474/115; 474/117; 474/79; 474/133; 474/135

(57) ABSTRACT

The invention is an improved belt drive system of the type having an automatic belt tensioner, an automatic belt tensioner pulley, a crankshaft pulley, an accessory pulley, and a power transmission belt trained about the automatic belt tensioner pulley, the crankshaft pulley, and the accessory pulley. It is improved by the inclusion of an initial tensioner.

### BACKGROUND OF THE INVENTION

1. Field of the Invention

This invention relates generally to a tensioner for tensioning a power transmission belt of a belt drive system and a system employing the tensioner. Particularly, this invention relates to a tensioner that provides an initial tension setting for a belt drive system and a system employing the tensioner including the system. Specifically, this invention relates to such a tensioner in an automatically tensioned power transmission belt drive system for internal combustion engine use.

2. Description of the Prior Art

It is known to use power transmission belt tensioners in conjunction with accessory belt drive systems for internal combustion engines that automatically accommodate system dimensional instability caused by variations in temperature and component operation or wear, or operational variation. Temperature changes affect both belt length and pulley geometry as the engine, accessories, and accessory mounts change dimension. Commonly, such automatic tensioners include a torsion, extension, or compression spring to force a pulley against a surface of the power transmission belt in a manner that creates a longer path for the belt and thus places the belt under tension.

Each such tensioner is designed to cause an optimum tension to be placed upon the belt for a specific geometry of pulleys in the system, the optimum design geometry, and a specific length of belt, the optimum design length. Sometimes such tensioners are optimized for a belt path assumed to occur after a brief wear-in period of power transmission belt drive system operation. In such cases, optimum design length is chosen to be that length that results after the brief wear-in period. The geometry of each such tensioner is dependent upon the spring rate of its spring over the distance of the spring's operation to determine the force produced by the tensioner at the pulley/belt junction. If the belt is shorter or longer than the specific optimum design length, while all other factors are at the specific optimum design geometry, then the spring will be deflected more or less, respectively, than optimum. Likewise, if the pulley geometry causes a longer or shorter path for the belt to follow than the optimum design geometry, while belt length is at optimum design length, then the spring will be deflected more or less, respectively, than optimum. Both effects can be present.

Power transmission belt drive system designers frequently strive to optimize drive systems in terms of minimizing belt width, against maximizing the life of the belt and other components. Further, the need for such optimization has increased as more demands have been placed upon belt drive systems. An example of a belt drive system meeting increased demand is one which includes a unitary device that performs both the engine start and alternator function, or motor/generator. Other examples can be found in the belt drive systems of certain hybrid automobiles.

There are substantial variations found in belt lengths applied to these belt drive systems. Even belts received from a single manufacturer, even over a single manufacturing run, necessarily vary in length over some given tolerance. It can be expected that the variations are more pronounced among different runs, particularly among different manufactures. This expectation is further exacerbated where the period between runs covers the time from when the belt is first installed to when it is replaced. There are also substantial variations in the geometry of the pulleys as placed upon an engine by an automotive manufacturer. Collectively, these are referred to as installation variations. Sometimes these installation variations neutralize each other. At other times, however, their affects are cumulative and result in wide variation.

These variations tend to frustrate optimization of belt drive systems which utilize automatic tensioners.

Prior to common use of automatic tensioners, the tension of belt drive systems were commonly set by manually positioning an accessory, such as an alternator and associated pulley, to provide a suitable belt tension. These are referred to as locked-center drives. A locked-center drive is not hampered by the installation variations just discussed. The installer simply moves the accessory until the desired tension is produced. However, a locked-center system cannot accommodate operational variations. Accordingly, locked-center drives are ordinarily set with tensions substantially above optimum so that the system will still function after some period of time. The locked-center drive is frequently re-tensioned to maintain it in functioning condition. These limitations have led belt drive systems to predominately include automatic tensioners.

Heretofore, power transmission belt drive systems have been limited to either accommodate installation variations, or operational variations, but not both. This has tended to frustrate system optimization. Accordingly, there is a continuing need for a power transmission belt drive system that can accommodate both installation variation and operational variation, which allows additional system optimization.

### SUMMARY OF THE INVENTION

The present invention has as an object the provision of an initial tensioner and a belt drive system including an initial tensioner which allows accommodation of both installation variation and operational variation.

To achieve the foregoing and other objects in accordance with a purpose of the present invention, as embodied and broadly described herein, an initial tensioner and a belt drive system including an initial tensioner are disclosed herein. The invention is an improved belt drive system of the type having an automatic belt tensioner, an automatic belt tensioner pulley, a crankshaft pulley, an accessory pulley, and a power transmission belt trained about the automatic belt tensioner pulley, the crankshaft pulley, and the accessory pulley. It is improved by the inclusion of an initial tensioner.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a schematic representation of a preferred embodiment of an accessory belt drive system configuration including an automatic tensioner and an initial tensioner;

FIG. 2 is a detail of an alternate preferred embodiment of an initial tensioner;

FIG. 3 is a detail of a nut forming part of the preferred embodiment depicted in FIG. 2;

FIG. 4 is a detail of a torsion spring forming part of the preferred embodiment depicted in FIG. 2;

FIG. 5 is a schematic representation of an alternate preferred embodiment of an accessory belt drive system configuration including an automatic tensioner and an initial tensioner;

FIG. 6 is a schematic representation of an alternate preferred embodiment of an accessory belt drive system configuration including an automatic tensioner and an initial tensioner;

FIG. 7 is a schematic representation of an alternate preferred embodiment of an accessory belt drive system configuration including an automatic tensioner and an initial tensioner;

FIG. 8 is a schematic representation of an alternate preferred embodiment of an accessory belt drive system configuration including an automatic tensioner and an initial tensioner;

FIG. 9 is a perspective view of a preferred embodiment of an initial tensioner;

FIG. 10 is a detail elevation, in partial section, of the initial tensioner depicted in FIG. 9 taken along line 10-10;

FIG. 11 is a detail elevation, in partial section, of an alternate derivative of the initial tensioner depicted in FIG. 10;

FIG. 12 is a perspective view of a preferred embodiment of a tensioner having both automatic and initial tension features;

FIG. 13 elevation view of another preferred embodiment of a tensioner having both automatic and initial tension features;

FIG. 14 a section of FIG. 14 taken along line 14-14; and,

FIG. 15 is another preferred embodiment of an automatic initializer to be used with the embodiment of FIGS. 13 and 14.

### DETAILED DESCRIPTION OF THE PREFERRED EMBODIMENTS

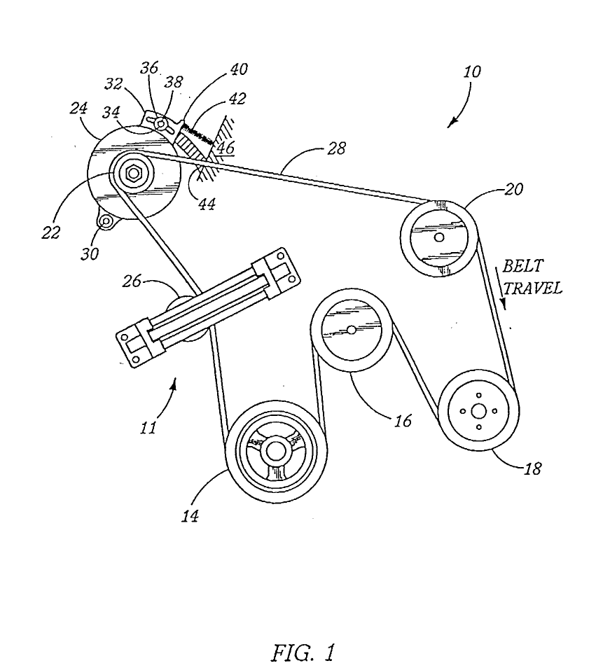

FIG. 1 depicts a preferred embodiment of an accessory belt drive system 10 including an automatic tensioner 11 and an initial tensioner 12. Automatic tensioner 11 is depicted as a single pulley linear tensioner, the details of which are described in co-pending application Ser. No. 09/969,404 which is incorporated herein. However, it is contemplated that the invention may be practiced any suitable design of automatic tensioner. The system 10 further includes crankshaft pulley 14, first accessory pulley 16, second accessory pulley 18, third accessory pulley 20, fourth accessory pulley 22, fourth accessory 24, automatic tensioner pulley 26, and power transmission belt 28 trained about pulleys 14, 16, 18, 20, 22, and 26, respectively. The accessories are among such items as water pump, power steering pump, air conditioning compressor, alternator, starter, or starter/generator. Fourth accessory 24 is depicted as an alternator, but could be any accessory. Also, there can be any number of accessories. Belt 28 can be of any type, but is commonly of the v-ribbed type. Initial tensioner 12 includes pivot 30, flange 32, brace bolt 34, washer 36, nut 38, spring support 40, spring 42, and brace 44. Spring 42 is depicted as a compression spring. However, a tension spring could be used if a stationary attachment point for spring 42 opposite of engine 46 from spring support 40 is selected. Brace 44 is mounted upon engine 46, stabilizes flange 32, and holds fourth accessory 24 stationary when nut 38 is tightened upon bolt 34, clamping washer 36 and flange 32 between brace 44 and nut 38.

System 10 is assembled, as depicted, but without belt 28 trained about the pulleys. Further, spring 42 is substantially fully compressed and held in that condition by the clamping of tightened nut 38. Also, tensioner pulley 26 is resting at the limit of its belt tensioning travel, the farthest right. In this condition, belt 28 is put into place. Nut 38 is then loosened which allows flange 32 to be free of the previous clamping. Spring 42 forces fourth pulley 22 into tensioning contact with belt 28. Spring 42 is selected to have a small spring constant as compared to that exhibited by automatic tensioner 11, but under greater compression to produce the necessary force. In this way, the amount of force produced by the spring, at the point where further movement of fourth accessory pulley 22 is prohibited by the tension of belt 28, will be near the optimum even after considering the installation variation. The tension upon belt 28 forces automatic tensioner pulley 26 in the belt loosening direction, left, to the point that automatic tensioner is placed under a load that corresponds to a belt tension that is near or at the tension determined to be optimum for the initial tension of system 10. Nut 38 is then retightened. Retightening is necessary for proper system 10 operation. If nut 38 is allowed to remain loose, substantial intermittent slippage of belt 28 will occur.

Application of this process to system 10 of FIG. 1 having initial tensioner 12, substantially accommodates installation variations and facilitates relatively easy belt installation. Spring 42 can also be absent from initial tensioner 12. In this configuration, after nut 38 is loosened, fourth accessory 24 is forced a distance that results in movement of automatic tensioner pulley 26 to a point predetermined to correspond to the optimum initial belt tension. Nut 42 is then retightened. This approach has the potential of greater optimization of initial tension. However, installation of belt 28 becomes impractically difficult.

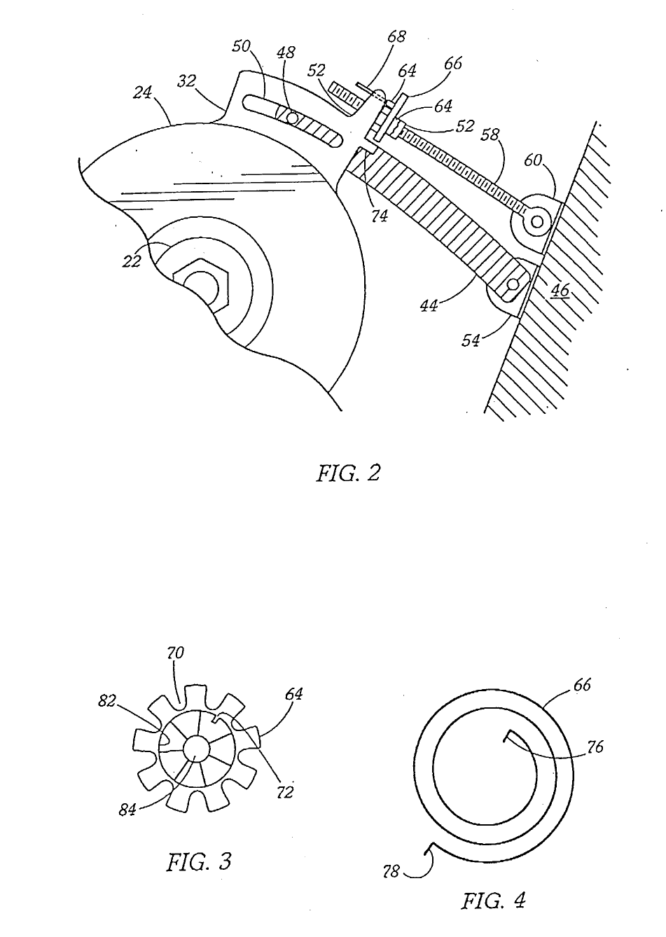

FIG. 2 depicts another embodiment of an initial tensioner including an automatic tension initializer. The initial tensioner is similar to the one depicted in FIG. 1 in that brace 44 continues to stabilize flange 32. However, bolt 34 is replaced by post 48, which rides in slot 50. Further, spring support 40 is modified to be flange standoff 52. Brace 44 connects to engine 46 via brace support 54.

The main difference is that spring 42, of initial tensioner 12, is replaced with an automatic tension initializer 56, comprising flange standoff 52, eyebolt 58, eyebolt support 60, torque limiter 62, notched nut 64, torsion spring 66, and pin 68. Notched nut 64 is depicted in greater detail in FIG. 3. Torsion spring 66 is depicted in greater detail in FIG. 4. Eyebolt 58 connects to engine 46 via eyebolt support 60. Torque limiter 62 is threaded upon eyebolt 58 and has a face opposite of engine 46 including first triangular teeth 80 which mate with second triangular teeth 82 on notched nut 64. Notched nut 64 has hole 84 that is not threaded and fits about eyebolt 62. Notched nut 64 also rests against torque limiter 62. A washer (not depicted) then fits over eyebolt 58 and against notched nut 64. Eyebolt 58 then fits through a hole in flange standoff 52. Pin 68 fits through another hole in flange standoff 52 and one of notches 70 of notched nut 64. Torsion spring 66 is wrapped about notched nut 64 ahead of notches 70 with first tang 76 inserted into first tang support 72. Second tang 78 rests upon second tang support 74.

Prior to putting belt 28 in place, torsion spring 66 is wound and torque limiter 62 is threaded near the base of eyebolt 58. Torsion spring 66 is held wound by the interaction of pin 68 and notch 70. After belt 28 is put into place, pin 68 is removed, allowing notched nut 64 to spin under the torque provided by torsion spring 66. The mating relationship of notched nut 64 with torque limiter 62, through teeth 80 and 82, causes torque limiter 62 to be spun and threaded down the shaft of eyebolt 58, pressing notched nut 64 and the washer against flange standoff 52. This, ultimately, forces fourth accessory pulley 22 to move forcefully against belt 28. When a predetermined amount of tension is placed upon belt 28, the reactionary force upon torque limiter 62 causes torque limiter 62 to resist further spinning to the extent that the mating relationship of teeth 80 and 82 begin to slip. The energy that remains in torsion spring 66, from the earlier winding operation, dissipates through the slippage of teeth 80 and 82. Thus, no additional force is applied to further tension belt 28. Accordingly, belt 28 has been supplied with an initial tension that is very close to optimum, in spite of installation variations.

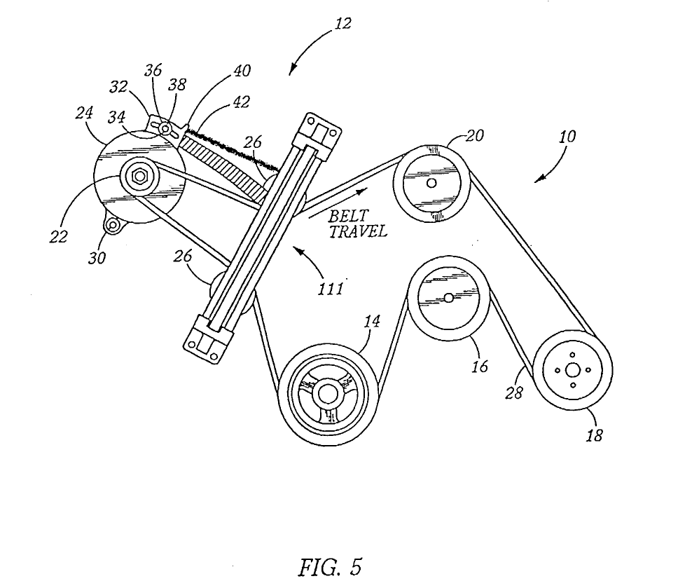

FIG. 5 depicts additional embodiments of system 10 and of initial tensioner 12 similar to the embodiments of FIG. 1. However, the single pulley tensioner has been replaced with a dual pulley tensioner 111 having second tensioner pulley 126. The details of dual pulley tensioner can be found in co-pending application Ser. No. 09/969,341, which is incorporated herein. Further, brace 44 and spring 42 are mounted to and incorporated into dual tensioner 111. Installation of belt 28, as it relates to initial tensioner 12, remains the same as for that depicted in FIG. 1.

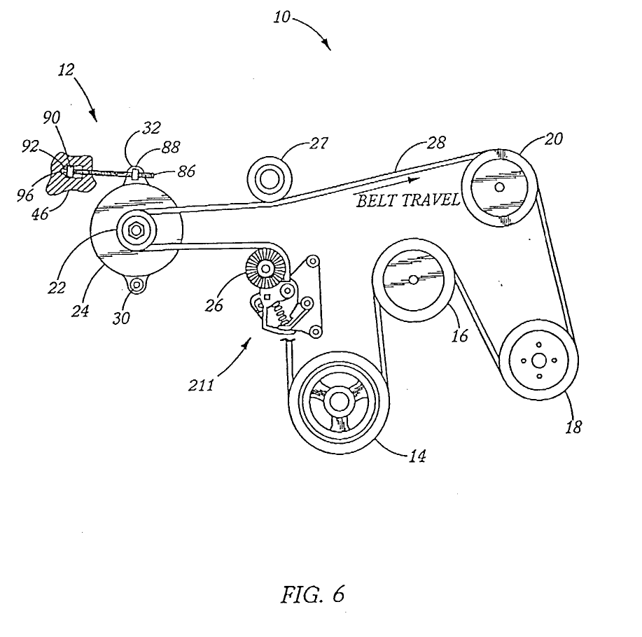

FIG. 6 depicts additional embodiments of system 10 and initial tensioner 12, similar to those depicted in FIG. 1. Automatic tensioner 11 has been replaced with a tensioner 211 of common design. An idler pulley 27 has also been added. Initial tensioner 12 now comprises jackscrew 86, jackscrew nut 88, flange 32, bracket 90, washer 92, and jackscrew head 96. Jackscrew nut 88 is threaded upon jackscrew 86. Jackscrew nut also is pivotally mounted to flange 32. Bracket 90 is mounted directly or indirectly upon engine 46. Jackscrew 86 passes through bracket 90 and washer 92 with its head 96 resting against washer 92. Prior to installation of belt 28, jackscrew 86 is loosened enough to allow placement of belt 28 about pulleys 14, 16, 18, 20, 22, 26, and 27. After placement of belt 28, jackscrew 86 is tightened to bring flange 32 closer to bracket 90 and thus pulley 22 into forceful engagement with belt 28. As tension is placed upon belt 28 through this process, tensioner pulley 26 is displaced. Once tensioner pulley 26 is displaced a predetermined amount, corresponding to the desired initial tension upon belt 28, tightening of jackscrew 86 is ceased.

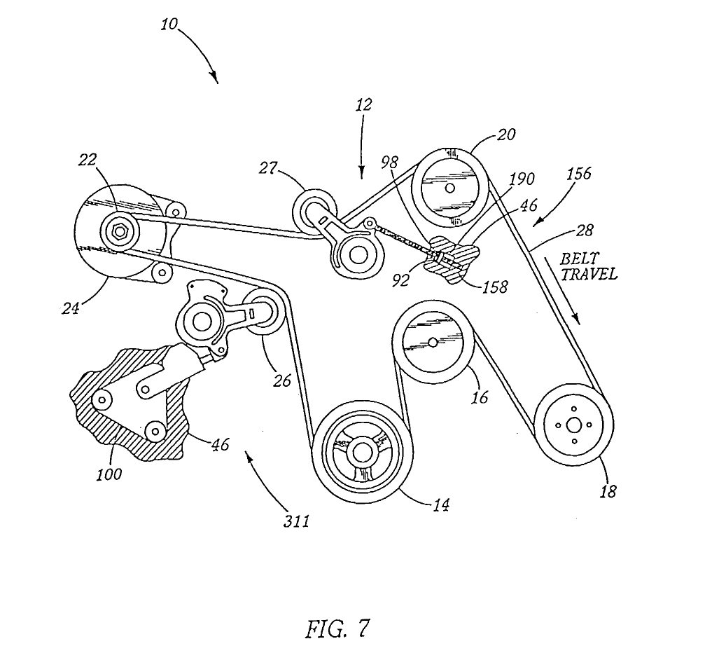

FIG. 7 depicts additional embodiments of system 10 and initial tensioner 112 where initial tensioner 112 is completely separate from any accessory. Automatic tensioner 311 is a replacement and another common type with connection to mounting plate 100 upon engine 46 depicted. Initial tensioner 112 comprises a pivotal arm 102 carrying idler pulley 27, and adjuster portion 156. Adjuster portion 156 comprises nut 98, washer 92, bracket 190, and eyebolt 158. Eyebolt 158 is swivel mounted upon pivotal arm 102 at flange 104, has nut 98 threaded upon it, and passes through washer 98 and bracket 190. Prior to installation of belt 28, nut 98 is loosened enough to allow placement of belt 28 about pulleys 14, 16, 18, 20, 22, 26, and 27. After placement of belt 28, nut 98 is tightened to push flange 104 farther from bracket 190 and thus idler pulley 27 into forceful engagement with belt 28. As tension is placed upon belt 28 through this process, tensioner pulley 26 is displaced. Once tensioner pulley 26 is displaced a predetermined amount, corresponding to the desired initial tension upon belt 28, tightening of nut 98 is ceased.

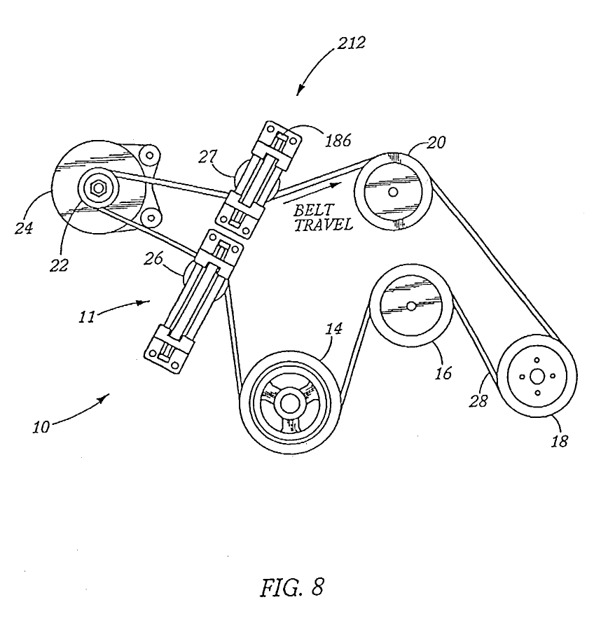

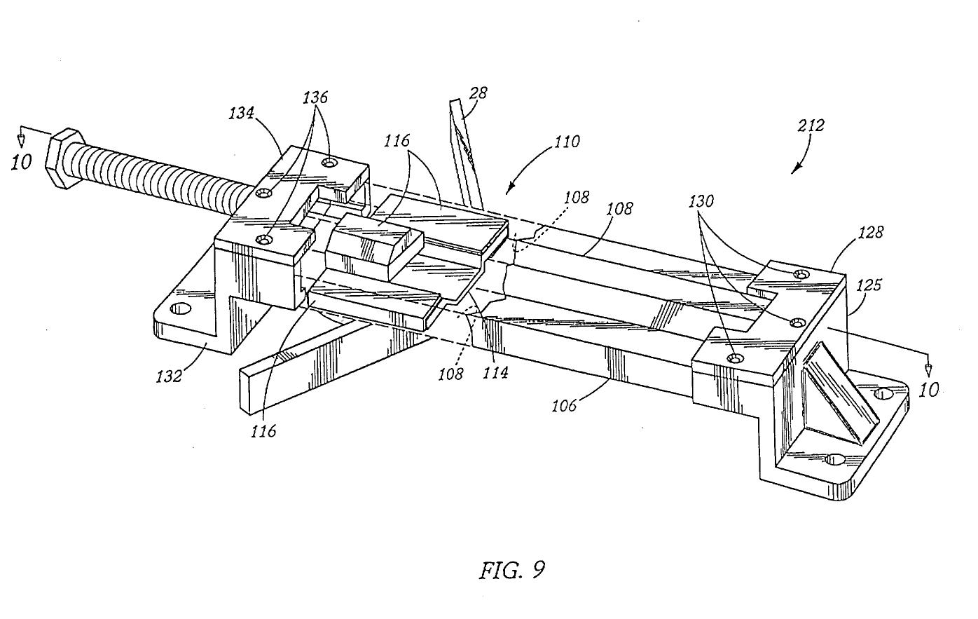

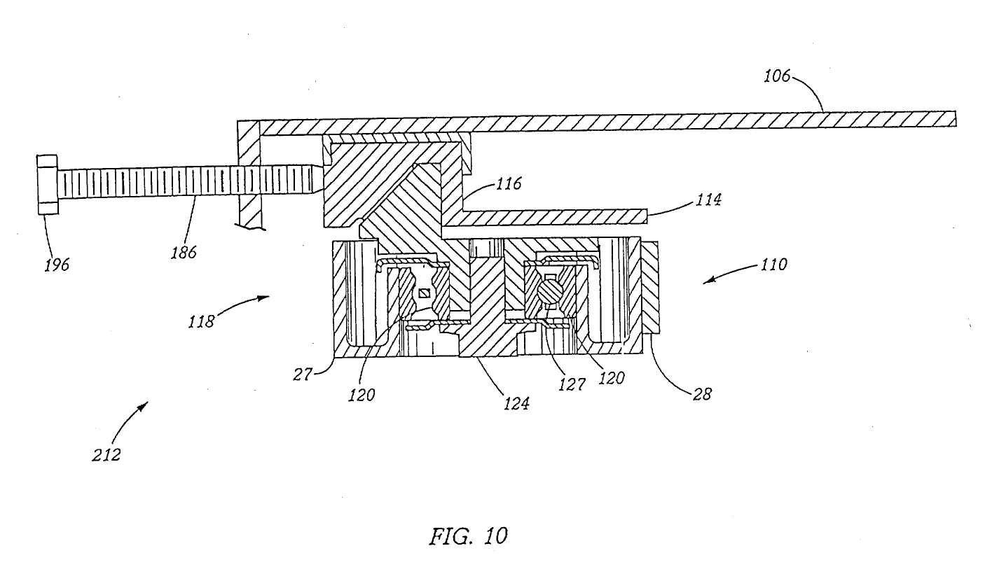

FIG. 8 depicts additional embodiments of system 10 and initial tensioner 212. Automatic tensioner 11 is like automatic tensioner 11 of the embodiment in FIG. 1. However, this embodiment of system 10 is like the embodiment of FIG. 7 including initial tensioner 212 being completely separate from any accessory. Only initial tensioner 212 is of a different embodiment and shown in greater detail in FIGS. 9 and 10.

Initial tensioner 212 comprises track 106 having three channels 108, carrier 110 having a base 114 upon which are three track bearings 116 and pulley assembly 118. Pulley assembly 118 includes races 120, and balls 122, and is affixed to base 114 with bolt 124. Once carrier 110 is assembled, it is placed in track 106. First end support 125 is secured to track 106 with first cap 128 and screws (not depicted) through first holes 130. Second end support 132 is secured to track 106 with second end cap 134 and screws (not depicted) through holes 136. Jackscrew 186 is threaded through second end support 132.

Prior to installation of belt 28, jackscrew 186 is loosened enough to allow placement of belt 28 about pulleys 14, 16, 18, 20, 22, 26, and 27. After placement of belt 28, jackscrew 186 is tightened to push carrier 110 farther from second end support 132 and thus idler pulley 27 into forceful engagement with belt 28. As tension is placed upon belt 28 through this process, tensioner pulley 26 is displaced. Once tensioner pulley 26 is displaced a predetermined amount, corresponding to the desired initial tension upon belt 28, tightening of jackscrew 186 is ceased.

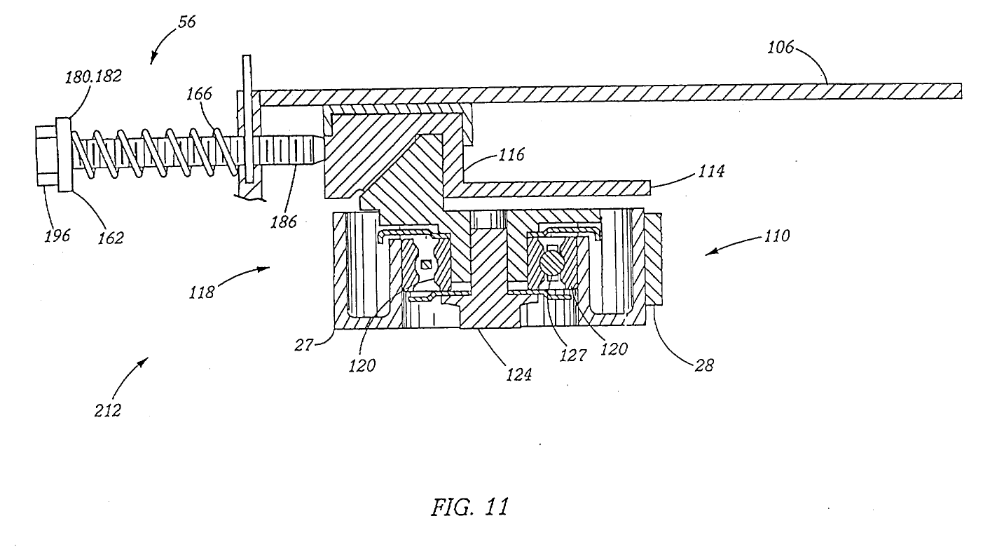

FIG. 11 depicts an embodiment of initial tensioner 212 similar to the embodiment of FIG. 10, but including tension initializer 56 comprising coil spring 166, pin 168, torque limiter 162, and teeth 180 and 182 upon torque limiter 162 and jackscrew head 196, respectively. Coil spring 166 wraps about jackscrew 186 and is affixed at one end to second end support 132 and to torque limiter 162 at its other end. Torque limiter 162 is not threaded and thus would spin freely upon jackscrew 186 but for the mating relationship of teeth 180 and 182. Torque limiter 162 and head 196 mate at teeth 180 and 182, respective, to effect the torque that can be placed across that junction at the point the junction begins to slip.

Prior to putting belt 28 in place, coil spring 166 is wound such that torque limiter 162 is urging jackscrew 186 to tighten, and held wound by the interaction of pin 168 and hole 170 in jackscrew 186. After belt 28 is put into place, pin 168 is removed, allowing jackscrew 186 to spin under the torque provided by coil spring 166. The mating relationship of head 196 with torque limiter 162, through teeth 180 and 182, causes jackscrew 186 to be spun and threaded toward carrier 110. This, ultimately, causes idler pulley 27 to move forcefully against belt 28. When a predetermined amount of tension is placed upon belt 28, the reactionary force upon head 196 causes head 196 to resist further spinning to the extent that the mating relationship of teeth 180 and 182 begin to slip. The energy that remains in coil spring 166, from the earlier winding operation, dissipates through the slippage of teeth 180 and 182. Thus, no additional force is applied to further tension belt 28. Accordingly, belt 28 has been supplied with an initial tension that is very close to optimum in spite of installation variations.

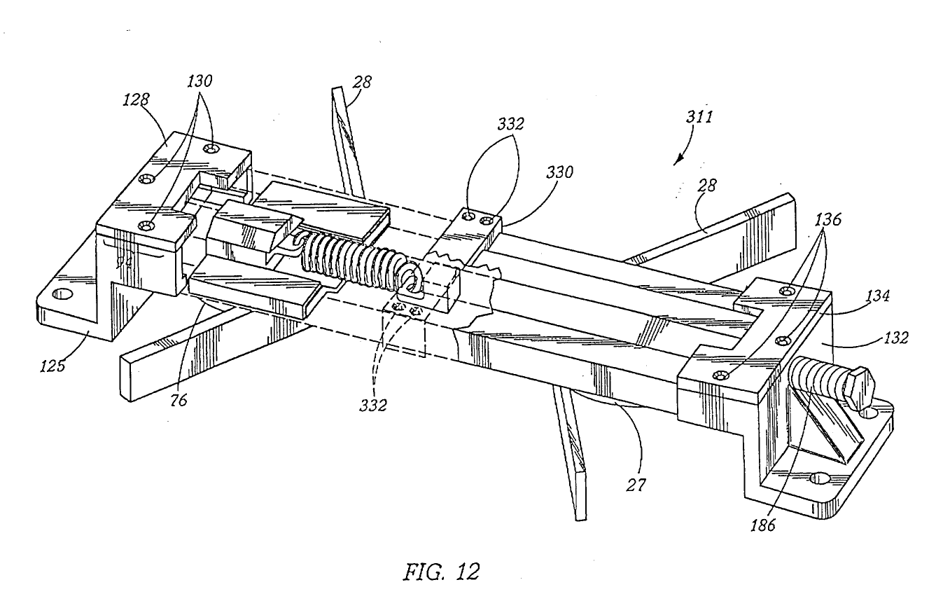

FIG. 12 depicts an automatic tensioner 313 having both automatic tensioner functions and initial tensioner functions. Automatic tensioner 11 of FIG. 1 is joined with initial tensioner 212 of FIG. 9 via intermediate support 330 and secured with screws (not depicted) in holes 332. Operation of this embodiment is the same as described in connection with the embodiment depicted in FIGS. 8, 9, and 10.

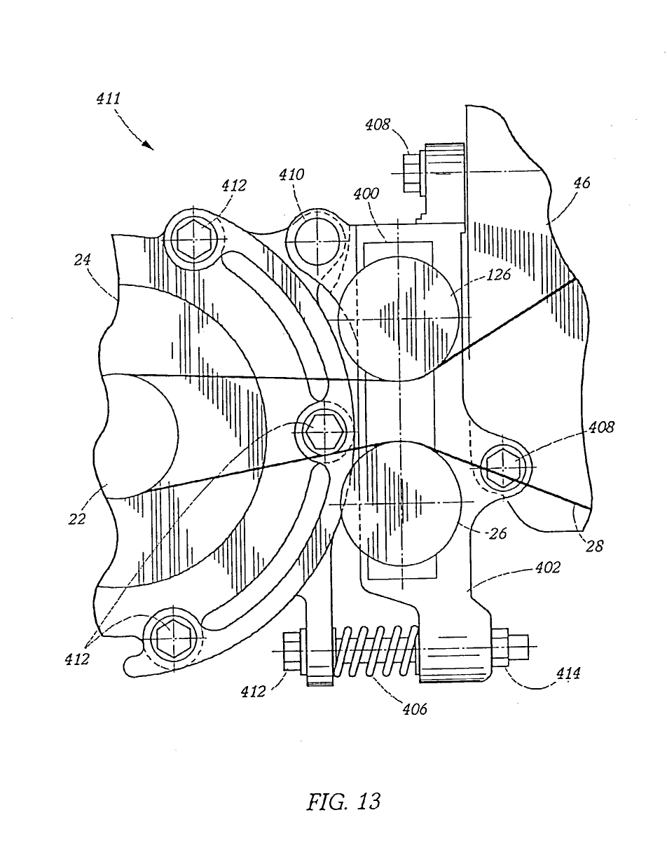

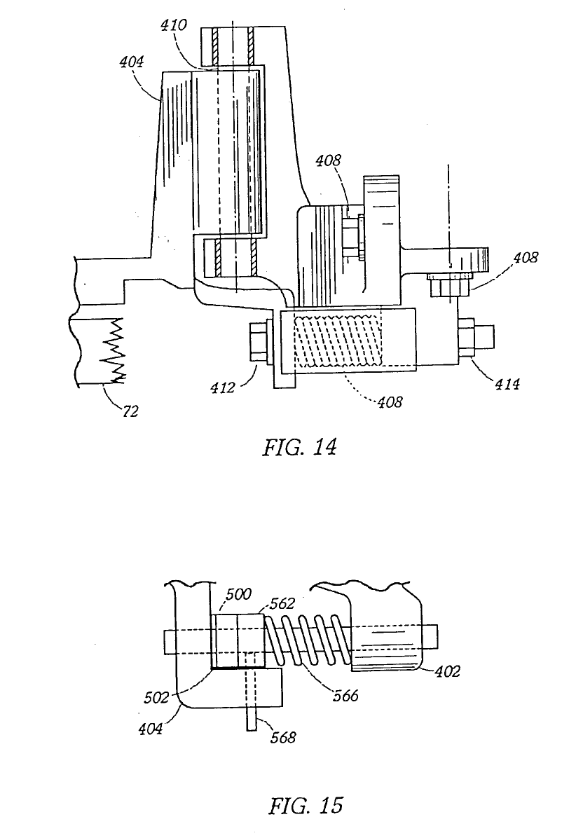

FIGS. 13 and 14 show a preferred embodiment of an automatic tensioner 411 having both automatic tensioner functions and initial tensioner functions. Dual pulley tensioner 400 is mounted in multifunction bracket 402. The details of tensioner 400 are described in co-pending application, serial No. 60/326,572, which is incorporated herein. Multifunction bracket 402 mounts to engine 46 by engine bolts 408. Accessory bracket 404 supports accessory 24, and is attached thereto by accessory bolts 412. Accessory bracket 404 is pivotally mounted upon multifunction bracket 402 via pin 410. The pivotal relationship of accessory bracket 404 with multifunction bracket 402 is limited by compression spring 406 and compression bolt 412.

Prior to installation of belt 28, compression bolt 412 is tightened enough to allow placement of belt 28 about pulleys 14, 16, 18, 20, 22, 26, and 27. After placement of belt 28, compression bolt 412 is loosened to allow compression spring 406 to push accessory bracket 404 farther from multifunction bracket 402 and thus fourth accessory pulley 22 into forceful engagement with belt 28. As tension is placed upon belt 28 through this process, tensioner pulleys 26 and 126 are displaced. Once tensioner pulleys 26 and 126 are displaced a predetermined amount, corresponding to the desired initial tension upon belt 28, loosening of compression bolt 412 is ceased. Locknut 414 is then tightened to secure the position of compression bolt 412.

FIG. 15 depicts an alternative to the portion A encircled on FIG. 13. It is an embodiment of an automatic initializer including threaded post 500, washer 502, torque limiter 562, with teeth 580 and 582, respectively, compression coil spring 566 connected on end to torque limiter 562 and the other end to multifunction bracket 402, and pin 568. Operation of this embodiment is very similar to the other embodiments of automatic initializers discussed previously. When pin 568 is pulled, spring 566 and torque limiter 562 spin threaded post 500 to the point that the mating relationship of teeth 580 and 582 begin to slip.

In sum, the preferred embodiments described herein and depicted in the Figures allow compact tensioners with linear movements and with the linear movement components of their interiors protected from debris and fluid by the environmental barrier arrangement.

The foregoing description and illustrative embodiments of the present invention have been shown on the drawings and described in detail in varying modifications and alternative embodiments. It should be understood, however, that the foregoing description of the invention is exemplary only, and that the scope of the invention is to be limited only to the claims as interpreted in view of the prior art. Moreover, the invention illustratively disclosed herein suitably may be practiced in the absence of any element that is not specifically disclosed herein.

I claim:

1. An improved belt drive system of the type having an automatic belt tensioner, an automatic belt tensioner pulley, a crankshaft pulley, an accessory pulley, and a power transmission belt trained about said automatic belt tensioner pulley, said crankshaft pulley, and said accessory pulley, the improvement comprising:
said belt drive system including an initial belt tensioner.

2. An improved tensioner for tensioning a power transmission belt of the type having a pulley for engaging said power transmission belt, the improvement comprising:
said tensioner further comprising an initial belt tensioning portion.

3. An automatic belt tensioner initializer comprising a rotary biasing member in communication with an extension arm via a torque limiter.
